(19) United States
(12) Patent Application Publication
(10) Pub. No.: US 2003/0112170 A1
(43) Pub. Date: Jun. 19, 2003

(54) Positioning system for ground penetrating radar instruments

(75) Inventors: Kyle J. Doerksen, Calgary (CA); Alan G. McNaughton, Calgary (CA)

Correspondence Address: MacPherson Kwok Chen & Heid LLP, Suite 195E, 2001 Gateway Place, San Jose, CA, 95110, US

(73) Assignee: KYMATIX RESEARCH INC., CALGARY (CA)

(21) Appl. No.: 10/278,483

(22) Filed: Oct. 22, 2002

(30) Foreign Application Priority Data
Oct. 22, 2001 (CA) 2,359,599

(51) Int. Cl. G01S 13/88; G01V 3/12

(52) U.S. Cl. 342/22; 342/52; 342/53; 342/54; 342/55; 342/56

(57) ABSTRACT

Existing positioning technologies used in conjunction with Ground Penetrating Radar (GPR) are generally too time-consuming or insufficiently accurate for high resolution, high frequency, 3-d structural investigations. The invention provides an optical positioning system for use in GPR surveys that uses a camera mounted on the GPR antenna that takes video of the surface beneath it and calculates the relative motion of the antenna based on the differences between successive frames of video. Positioning accuracy to within several millimeters is provided. The procedure is orders of magnitude faster than surveying a grid of data points or laying out parallel lines and surveying each line with an odometer wheel. The system and method of positioning is suitable for mapping the subsurface of structures such as building columns or floors using GPR. Time domain synthetic aperture radar algorithms can be used to reconstruct an image of the subsurface using this position data.

### FIELD OF THE INVENTION

The present invention relates generally to precise positioning for subsurface investigation particularly with ground penetrating radar.

### BACKGROUND OF THE INVENTION

It is well known that radar energy that reflects off objects embedded in a medium, or off of sudden changes in the properties of the medium, can be used to understand the gross internal structure found inside the medium. This use of radar is commonly called Ground Penetrating Radar (“GPR”). GPR can be used to detect detail inside a structure such as column or wall or floor. Voids, rebar, conduit, cables, changes in material and material thickness can be detected.

Often the GPR unit is moved along a supposedly straight line on the surface. This transect commonly has radar returns recorded at a fixed interval, such as every two centimeters, along the line. The start and end points of this line or the whole line are often manually marked on the surface being investigated. The data from a single transect can be processed to provide some useful information about the internal structure.

While a single transect can provide some useful information of the subsurface object distribution, further information and greater detail about the inside of the structure can be learned by gathering enough transects in close proximity to each other that a three dimensional reconstruction of the inside of structure can be generated. One challenge of using multiple transects is accurately knowing the location of each transect. The common solution when attempting this is to manually mark out a series of parallel lines on the structure. The operator of the GPR unit then manually moves the GPR instrument along each marked line. Considerable position error is introduced based on the inability of the human operator to follow these pre-drawn lines exactly. This may be as a result of surface irregularities that the radar must be moved around, or as a lack of hand eye coordination of the user, or a combination of those and of other external stimuli, difficulties maintaining even tracking speed, attitude and location of the GPR source and sensor unit. This positioning error reduces the accuracy of the three dimensional image that can be generated from the data.

There are three common methods to obtain position information corresponding to the radar data: 1) the GPR unit is moved at an approximately fixed velocity by hand by the operator with radar readings being taken at set time intervals that will yield approximately the desired point spacing; 2) a measuring wheel (odometer) is incorporated into the GPR unit that triggers the data collection at set intervals of linear travel; and 3) the operator manually triggers the reading at set intervals based on grid markings previously made on the structure or based upon a tape measure or marked string.

All three of the largely manual positioning techniques described above are poorly suited for three dimensional GPR imaging of structures due to the relatively large and inconsistent or unpredictable positioning error introduced

More recently, two additional methods have been employed to gather the position information: 1) a Differential Global Positioning System (“DGPS”) where one Global Positioning System (“GPS”) antenna is mounted to the GPR instrument and as the radar data is collected, the GPS co-ordinates are collected at the same time; and 2) a self-tracking laser theodolite is pointed at a reflector located on the GPR and the laser constantly tracks the location of the GPR instrument, calculating the GPR instrument position based upon the angle of the laser and the laser pulse return time.

While the use of differential GPS is well suited to outdoor use when surveying large areas while looking for large objects, it is poorly suited for positioning on a structure for several reasons. First, the position error is large relative to the depth of investigation and the object resolution desired for most structural investigation. When looking at rebar within a concrete structure you maybe looking at objects with a 20 mm diameter at depths from just below the surface to 300 mm deep. An X,Y position error of 20 mm and a Z (vertical) position error of 60 mm would be the typical position error of a DGPS system. This limits the usefulness of DGPS for this type of fine structural investigation. The other major limit of DGPS is that often the location where the work is being done is where GPS will not work It is either indoors or, when outside, close to walls and other obstructions that obscure the necessary line-of-site to multiple GPS satellites.

It is further known that laser positioning provides much better position accuracy than the other methods and is indeed suitable for GPR investigation of structures, including indoors use. It does however have a high cost and requires that line-of-site be maintained between the GPR instrument and the laser positioning system that is at a known location.

### SUMMARY OF THE INVENTION

It is an object of the Invention to overcome limitations in the prior art as there exists a need for a low cost highly accurate positioning system for use with GPR and other instruments used to investigate what is inside structures. It is desirable that the position information be automatically collected and recorded along with the GPR data via a system and method of providing precise positioning necessary for three dimensional imaging of internals of structures using GPR and electromagnetic or other suitable remote subsurface feature detection instruments.

These and other objects and advantages of the Invention are apparent in the following description of embodiments of the Invention, which is not intended to limit in any way the scope or the claims of the Invention.

### BRIEF DESCRIPTION OF THE DRAWINGS

Embodiments of the present invention will now be described, by way of example only, with reference to the attached FIGURES, wherein:

FIG. 1 is a plan view representation of a GPR data collection antenna affixed to an optical displacement sensor (and is the representative drawing).

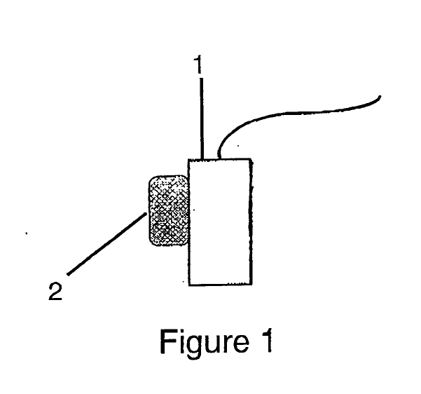

### DETAILED DESCRIPTION

The following described embodiments of the Invention display preferred compositions but are not intended to limit the scope of the Invention. It will be obvious to those skilled in the art that variations and modifications may be made without departing from the scope and essential elements of the Invention.

A GPR instrument, or other like subsurface feature detection instruments1, can be coupled with optical navigation technology2 to create a system for internal structure data collection that has highly accurate positioning. The positioning is sufficiently accurate so that it is suitable for three dimensional imaging of features within the desired size and position ranges, and the incremental system cost above the cost of the bare GPR instrument is small. The system has the added advantage that the operator does not need to move the instrument in a highly ordered fashion over the surface. Also, an arbitrary data collection pattern can be used and does not need to be predetermined. In fact, the data collection does not need to follow any preconceived or repeatable pattern at all and the movements of the instrument over the surface can be totally arbitrary or done to the operator's convenience or judgement, as long as sufficient data is collected in all the regions of interest.

Optical navigation is now highly developed in computer mice. The method involves capturing an image and then analyzing and tracking the motion of microscopic texture or other features on a surface along which the mouse is moved. Optical mice depend on tracking the surface detail and it is now understood that most surfaces are microscopically textured. When a light source such as a light emitting diode is used to illuminate these surface textures, a pattern of highlights and shadows is revealed. Optical mice “watch” these surface details move by imaging them onto navigation integrated circuits (IC). Typically the optical-navigation IC captures images at the rate of over 1,000 pictures per second, using a small 16-by-16-pixel image sensor. As each image is captured, it is transferred to the processing and computation section of the navigation circuit, where the movement of the mouse is computed by comparing successive images. Such a system can detect movement of the mouse relative to the surface in any direction. This yields relative position which, when measured relative to markers or targets at known surface locations, can be transformed into real world coordinates. Rotation (or relative attitude or “pitch and yaw” of the GPR unit's scanning function's focus of attention) can be detected by further processing of the returned image stream. Alternately, two optical positioning sensors with some distance separating them can be used to measure their relative movement and thus resolve orientation information.

When the system is first placed on the surface to be investigated, the X,Y starting point is set to some coordinates entered by the user in order to give an absolute positioning reference to the system. The system then records all relative movements from the starting point so that at all times the system knows its X,Y location with respect to the starting point. Once the scan of an area is started, the system must at all times remain in contact with the surface in order to “know” or sense or calculate or infer its location. If it loses contact with the surface, it would need to be returned to a reference marker, and then the scan could continue. The user interface can inform the user when the system has been off the surface by way of an audible or visual indication. Positioning system drift can also be corrected by returning to a reference marker. Multiple reference markers at known locations on the surface of the subject of interest can be used (that is, tracked over and noted or referenced during the scanning process) to further increase accuracy over a single marker. As the system begins recording data, in the case of GPR the amplitude of the return radar signal with respect to time, the system also records the surface position at the same time. The optics on current low cost optical sensors have a very limited range of focus, so it is important that the sensor remain in physical contact with the surface under survey. With improved DSP technology and algorithms, larger image sensors and improved optics, it may be feasible to perform processing at a standoff. Currently we overlay a flat, radar-transparent plastic sheet marked with reference markers (or waypoints) over the region of interest.

Due to instrument drift, accuracy decreases with the distance traveled since the last way-point. The observed degree of error is small compared to relevant Nyquist intervals. This type of error is also correctable in postprocessing when the instrument is passed over known way-points. These way-points can be used as control points for a deformation mapping. To generate the transform, three points and their “correct” spatial positions must be known. A simple affine mapping can be used to correct the data. Higher order methods such as piecewise polynomial transformations can also be used.

To increase accuracy the user interface can indicate to the user either audibly or visually when the instrument has moved too far since passing over a know waypoint.

The optical navigation device (“OND”)2 can not readily be positioned co-incident with the surface penetrating instrument. For example with GPR it would be desirable to locate the center of the OND at the center point between the radar transmitter and the radar receiver1. Since this is not practical for reasons of physical room and interference with the radar signals, the OND must be located elsewhere on the system. An offset between the center of the OND2 and the center of the surface penetrating instrument1 must be known and used in calculating or inferring tie position of the GPR's measuring location.

When the system is moved over the surface of a structure it is useful to have a method of indicating which areas of the surface have been covered. This may be done by displaying the movement of the system on a display that traces out lines showing where the investigative center of the system has been. (Alternatively, the GPR/OND system may also have installed a physical marking device.) The display can assist the user with moving over an area by showing a guiding pattern on the display that the user attempts to follow. For example, the display may show a serpentine pattern to be followed to cover a rectangular area. The serpentine pattern would be displayed in one color or as a dashed line. The actual path traversed by the operator would be displayed in another color or as a solid line. The fact that the user does not exactly follow the offered tracing pattern does not reduce the quality of the image that can be generated from the radar data since the actual location that each data point was collected at is recorded with high accuracy by the system. This actual location, not the intended location, is used in the processing algorithms. The serpentine pattern can be designed to guide the user toward an optimal scanning pattern for the item of interest being scanned, and can be tailored or pre-configured. An alternate display can show which areas have had sufficient data sampled over them to provide high confidence estimates of buried object distributions. False color could be used to indicate which regions are sufficiently sampled and which require more data to be collected If a physical marking device is used, protocols for adequacy of coverage would be developed for the operator's reference.

When the radar or EM data collected with the system is processed into a three dimensional image or a plan view, it is necessary to be able to orient or spatially register the processed data with the object that was scanned. The conventional method of marking the surface with paint or chalk at the time it was scanned can still be practiced with this new system. Alternatively, a new method can now be practiced that uses targets placed on the surface being scanned. These targets in one embodiment take the form of a small adhesive label stuck to the surface. The target is recognizable by either the OND or the radar or both, or the user may input that the system is over a given marker, and if desired, at a particular time. The OND or radar can be passed over the target to set the starting point of the scan. The center of the target becomes a known co-ordinate of the scan. If the surface of the area being surveyed is not flat or geometrically simple, then geometry correction algorithms is can be applied if registration marks are located in known positions and the surface geometry is known or can be modelled. For example the position on a round pillar could be correctly determined if the diameter of the pillar is provided to the system Irregular surfaces can also be modelled if they can be mathematically described.

Another method of collecting data is to attach a paper or thin plastic template or web of lines to the surface of the structure being investigated. This template may be printed with a starting point and a pattern to follow, OOr it may simply act as a smooth surface over which to move the scanner. Again the users adherence to the pattern is not critical for accuracy since the precise location actually achieved is recorded. The purpose of the template is simply to provide a method of guiding the user to collect sufficient data over the area of the template and to provide for lining up registration marks of the template with registration marks from the results. The template can be left on the surface and then its registration marks can be used when overlaying a print out of the processed results. The results or a section of the results along with annotations can be printed on a full scale. Overlaying the full scale results on the surface of the scanned object can assist with visualization by persons or equipment in later cutting or coring or further investigation of the structure. In some cases, the detected subsurface features could be directly projected onto the surface using a digital projector, or overlayed on a user's field of vision by retinal projector or head's up display (for example).

All components used in the Invention may be comprised of any suitable system or systems, including but not limited to GPR and electromagnetic instruments.

In the foregoing descriptions, the Invention has been described in known embodiments. However, it will be evident that various modifications and changes may be made without departing from the broader scope and spirit of the Invention. Accordingly, the present specifications and embodiments are to be regarded as illustrative rather than restrictive.

The descriptions here are meant to be exemplary and not limiting. It is to be understood that a reader skilled in the art will derive from this descriptive material the concepts of this Invention, and that there are a variety of other possible implementations; substitution of different specific components for those mentioned here will not be sufficient to differ from the Invention described where the substituted components are functionally equivalent.

We claim:

1. An apparatus comprising:
(a) an x, y change sensor;
(b) a non-destructive subsurface survey instrument; and
(c) data storage means operatively connected to both sensor and instrument for collection of data to enable accurate location of the instrument on the surface of surveyed item of interest.

2. The apparatus of claim 1 where the x, y change sensor is an optical navigation device.

3. The apparatus of claim 1 where the x, y change sensor includes a camera.

4. The apparatus of claim 1 where the x, y change sensor is comprised of:
(a) a lens;
(b) a light source;
(c) an array of light sensors;
(d) computational capability.

5. The apparatus of claim 5 where the array of light sensors is an array of CCD devices.

6. The apparatus of claim 1 where the instrument is chosen form the following list of instrument type: ground penetrating radar, ultra-wide-band radar; ultrasonic; electro-magnetic; electro-magnetic pulse or magnetic resonance instruments in single source, single receiver, arrayed source or arrayed receiver configurations or any combination of those types.

7. The apparatus of claim 1 where the data is used to calculate a tomographic representation of the surveyed subsurface.

8. A method of surveying an item of interest for subsurface features comprising the steps of:
(a) placing a non-destructive subsurface survey instrument in proximity to the surface of the item of interest;
(b) causing the instrument to take a measurement of subsurface features of the item of interest;
(c) at substantially the same position recording the instrument's absolute position by reference to a known position on the surface and calculated x, y movement across the surface from that known position, of the instrument.

9. The method of claim 8 where the x, y movement calculation is done by reference to surface features sensed by optical means capable of sensing and providing x, y position change data, said optical means at a location at or near the instrument.

10. The method of claim 8 where the known position is either a starting position or a way-point position along a series of surveyed positions.

11. The method of claim 8 with the added step of providing markings on the surface of the item of interest at substantially the same time as a record of the mark is made in the collected data set of the survey for later correlation of survey results to the item's actual surface.

12. The method of claim 8 with the added step of providing the operator with indications on the surface of where the instrument has already surveyed.

13. The method of claim 8 with the added step of providing the operator with indications on the surface of where the instrument should be directed to survey.

14. The method of claim 8 where the survey results are projected on the surface during the process of survey to provide guidance to the operator, or afterwards to provide indications for further attention.

15. The method of claim 8 where the positioning calculations resolve relative x, y position by comparing successive frames of video taken from a camera pointed at the surface, correlating them spatially, and interpolating the distance that the sensor moved.

16. The method of claim 8 where the absolute position is calculated by compensating for the offset between the position sensor and the investigative center of the subsurface investigation instrument, and then referencing the relative position to way-points at known locations to eliminate instrument drift and transform the co-ordinates into real world co-ordinates.
